(19) United States
(12) Patent Application Publication
(10) Pub. No.: US 2014/0047049 A1
(43) Pub. Date: Feb. 13, 2014

(54) METHODS AND SYSTEMS FOR LINKING AND PRIORITIZING CHAT MESSAGES

(71) Applicant: Milyoni, Inc., Pleasanton, CA (US)

(72) Inventors: Regan Poston, Menlo Park, CA (US); David Raycroft, San Francisco, CA (US)

(73) Assignee: Milyoni, Inc., Pleasanton, CA (US)

(21) Appl. No.: 13/961,783

(22) Filed: Aug. 7, 2013

Related U.S. Application Data
(60) Provisional application No. 61/680,678, filed on Aug. 7, 2012.

(51) Int. Cl. H04L 12/58

(52) U.S. Cl. CPC H04L 51/32
USPC 709/206

(57) ABSTRACT

Embodiments are directed at methods and systems for facilitating social interactions between viewers watching media inputs and interacting with each other before, during, and after the viewing process. One embodiment is directed to delivering chat messages to a user computer. The method comprises receiving a request including a user identifier from the user computer and determining a first user account associated with the user identifier. The method further comprises calculating an importance score for a plurality of chat messages. The importance score may be calculated for the first user account differently than for a second user account. The method further comprises selecting a first set of chat messages. The first set of chat messages may have a specified number of chat messages with importance scores that are highest amongst the chat messages. The method also comprises sending a response including the first set of chat messages to the user computer.

### CROSS-REFERENCES TO RELATED CASES

The present application is a non-provisional application of and claims priority to U.S. Provisional Application No. 61/680,678, filed on Aug. 7, 2012, the entire contents of which are herein incorporated by reference for all purposes.

### FIELD

Embodiments of the invention relate generally to social media interactions and specifically to prioritizing and segmenting chat messages within interactive social media presentation environments.

### BACKGROUND

The rise of easy networking between computers and computing devices used by multiple people at disparate locations eventually led to the development of online social interaction, social networks and other activities that involve multiple people, typically at more than one physical location with interaction mediated via a network carrying data between clients, servers and nodes associated with various individuals and computers or computing devices.

Social media interactions might include interactions that are mediated by social media services that operate social media servers that connect users, such as the Facebook™ service, the Myspace™ service, the LinkedIn™ service, the Twitter™ service, and other online social-oriented membership and non-membership communities mediated by their respective services.

Generally, these online communities are made up of a plurality of registered users who provide information about themselves (or avatars) that are shared with other members who post information about themselves. Many services can be provided to these users through the social media website including the sharing of information, networking, dating, advertising, and the delivery of media.

As users engage more in social online interactions, there is more demand for more varied interactions, especially interactions directed at sharing information amongst users and otherwise interacting with one another.

Embodiments of the present invention solve these problems and other problems, individually and collectively.

### BRIEF SUMMARY

Embodiments of the invention are directed to methods, computer apparatuses, and systems for facilitating social interactions between multiple user computers and providing an interactive social experience for distributed viewers of media inputs over a communications network. Specifically, embodiments of the present invention are directed at linking and prioritizing chat messages so that user computers receive the most relevant, important, and interesting chat messages for each user. Accordingly, chat messages may be segmented, provided an importance score that is tailored for each and every user, and the chat messages may be displayed to those users that may most likely find the chat message interesting and useful. Accordingly, chat messages may be separated, linked, and prioritized for user display, according to system and user preferences.

Embodiments of the invention provide the advantages of allowing users (e.g., viewers) to engage with media content and fellow viewers in new and interesting ways. Viewers are more engaged with the content because their social contacts or friends use the media to have a more fulfilling experience. Embodiments of the invention further provide advertisers a method of interacting and engaging with consumers in ways previously unavailable. Furthermore, content providers can deliver customizable media and numerous options to users in order to keep them engaged with their media or associated products. Finally, increased sponsorship revenue and service delivery opportunities are provided due to the increased viewer engagement with the media content.

One embodiment of the present invention is directed to a method for delivering chat messages to a user computer. The method comprises receiving a request including a user identifier from the user computer and determining a first user account associated with the user identifier. The method further comprises calculating an importance score for each of a plurality of chat messages. The importance score may be calculated for the first user account differently than for a second user account. The method further comprises selecting a first set of chat messages. The first set of chat messages may have a specified number of chat messages with importance scores that are highest amongst the chat messages. The method also comprises sending a response including the first set of chat messages to the user computer.

Another embodiment of the present invention is directed to a computer product comprising a non-transitory computer readable medium storing a plurality of instructions that when executed control a computer system to deliver chat messages to a user computer. The instructions comprising receiving a request including a user identifier from the user computer and determining a first user account associated with the user identifier. The instructions further comprising calculating an importance score for each of a plurality of chat messages. The importance score may be calculated for the first user account differently than for a second user account. The instructions further comprising selecting a first set of chat messages. The first set of chat messages may have a specified number of chat messages with importance scores that are highest amongst the chat messages. The instructions also comprising sending a response including the first set of chat messages to the user computer.

These and other embodiments of the invention are described in detail below.

### BRIEF DESCRIPTION OF THE DRAWINGS

FIG. 1 shows an example system for delivering reconfigured media content to users through a reconfigured media presentation system, according to one embodiment of the invention.

FIG. 2 shows an example of a block diagram of a reconfigured media server, according to one embodiment of the invention.

FIG. 3 shows a flow diagram of a method of delivering reconfigured media inputs as well as methods for delivering prioritized chat messages to a user computer within a reconfigured media presentation system, according to embodiments of the present invention.

FIG. 4 shows a flow diagram of a method of delivering prioritized chat messages to a user computer within a reconfigured media presentation system, according to embodiments of the present invention.

FIG. 5 shows a flow diagram of a method of segmenting chat messages into social groupings, according to one embodiment of the present invention.

FIG. 6 shows an example of a screenshot of a user interface, according to embodiments of the present invention.

FIG. 7 shows an example of a screenshot of a user interface, according to embodiments of the present invention.

FIG. 8 shows an example of a chat message database data structure, according to embodiments of the present invention.

FIG. 9 shows an example of a computer system, according to embodiments of the present invention.

### DEFINITIONS

Prior to discussing embodiments of the invention, a further description of some terms can be provided for a better understanding of the invention.

A “user” may include any person or entity that interacts with a reconfigured media provider to view or interact with reconfigured media inputs. For example, a user may be a person that is registered to purchase, use, interact with, or view a movie through a reconfigured media presentation system. A user may also include a celebrity, moderator, persona, or other designated person that uses the social media presentment system to moderate, operate, direct, or otherwise has a special role outside of viewing or interacting with a media input.

A “user identifier” may include any unique identifier for a registered user of the reconfigured media presentation system. The user identifier may be provided by a reconfigured media provider, social media network, a user, or any other entity in the reconfigured media presentation system. The unique identifier may uniquely identify a user for all purposes within a reconfigured media presentation system. Accordingly, the user identifier may be used to obtain information about a user request, past preferences, past activities, etc. associated with the reconfigured media provider, a social media network, or any other entity within the reconfigured media presentation system.

A “user account” may include a registered account at any entity within the social media presentation system. The user account may comprise any information that may be collected regarding the user. For example, the user account may include information provided during registration, information that may be collected from a user profile associated with the user at a social media website, information obtained from the user's interactions with a reconfigured media provider, or any other information that may be obtained from the reconfigured media provider or any other entity within the social media presentation system.

A “user profile” may include any information provided by a user regarding their interests, preferences, other users they know (i.e., friends, family members, etc.), or any other information they may provide an entity within the social media presentation system.

A “reconfigured media provider” may include any entity that incorporates, includes, generates, adds, or otherwise provides non-media inputs associated with a media input for presentation to users. The reconfigured media provider may provide the media input and the non-media input directly to a user or may link or otherwise provide information to the user regarding where they can find the reconfigured media input.

A “media content provider” may include any entity that produces content. For example, a media content provider may include a band, artist, production company, record label, or any other entity that generates content for user consumption. Typically, a media content provider may provide a media input to a content delivery network or other entity to convert the media input into a format that is capable of being transmitted across the internet or other communications networks to requesting user computers.

A “content delivery network” may include any entity configured to deliver media inputs to user computers. Typically, media content providers generate media inputs and provide the media inputs to content delivery networks to actually send content to requesting user computers. Further, third parties may reference or otherwise provide a link to content provided by a content delivery network to user computers as a means for delivering content. For example, the reconfigured media provider may send a link to a media input that is stored on a content delivery network as part of the reconfigured media input that is delivered to a user computer. Further, content delivery networks may use various media players, content formats, and media files when delivering content to user computers.

A “media input” may include a film, song, TV episode, or any other digital media that is provided by a content provider prior to a user's viewing experience. The media inputs can be delivered for educational, entertainment, safety, or any other information sharing purposes. The media input may be a live broadcast (i.e., a live “stream”) or a pre-recorded media event. The media input may be stored at a content delivery network and may be associated with a product stored by the reconfigured media provider.

A “non-media input” may include inputs that are generated by viewers (i.e. users), those experiencing the media, by the system administrator (e.g., event producer, organizer, etc.), or by entities associated with a media input (e.g., advertisers, content providers, etc.) and are not part of the originally generated presentation (e.g., concert, movie, etc.). Non-media inputs could include the actions of a viewer to interact with another viewer or the system before, during, or after the viewing of a media presentation. For example, non-media inputs could include comments made during the viewing of a movie or TV episode that are either shared with another viewer of the presentation or saved at a particular time in the media for later viewing by other users.

A “reconfigured media input” may include any reference to both a media input and the non-media input associated with the media input. Accordingly, the reconfigured media input may be a single file or communication including both the media input and the non-media input, may include the non-media inputs and links to the media input that may be provided by a content delivery network, may include only links to both the media input and the non-media input that are both provided by content delivery networks, or may include any combination thereof.

A “media identifier” may include any information that allows an entity to identify a media input associated with a communication. For example, a media identifier may be a common identifier that is shared amongst all of the entities within the social media presentation system so that a media input, non-media inputs, or reconfigured media inputs may be identified by any of the entities within the social media presentation system.

A “chat message” may include any information that is generated by a user, operator, provider, or any other entity of the reconfigured media presentation system that is shared with another user computer of the reconfigured media presentation system. The chat message may be associated with a reconfigured media input and may be received through any number of communications channels. For example, a chat message may include a text, graphic, picture, or other information that is entered by a user operating a user computer using a reconfigured media presentation system user interface, a social media network communication (e.g., a Tweet®, comment, post, or other information provided to a social media network), an email message or other message provided to fan page associated with a media input, an advertisement originating from a sponsor, content provider, or other entity of the reconfigured media presentation system related to a media input, or any other information that may be related to a reconfigured media input provided by the reconfigured media presentation system.

A “chat message author” may include the user, person, organization, moderator, celebrity, or any other identifiable entity that submits, initiates, or generates a chat message. For example, a chat message author may include a user commenting on a movie they are watching by entering a chat message. Further, the chat message author may be an advertiser that provides a chat message to be shown as part of the non-media inputs for a reconfigured media input. Accordingly, chat message authors may be identified by type. For example, chat message authors may be considered users, advertisers, celebrities or personas, content providers, or moderators. Additionally, any other suitable types of authors may be identified and used. In some embodiments, chat messages may be treated differently depending on the type of chat message author.

A “chat message channel” may include any communication means in which a message may be delivered to or displayed by a reconfigured media provider. For example, chat message channels may include multiple different social media websites, fan sites, a recorded playback of a reconfigured media input vs. a live stream of a reconfigured media input, or any other possible means for a message to be shared with or captured by the reconfigured media server.

A “request” may include any message or series of messages sent from a client computer to a server computer for any information. For example, a chat message request may include a request for chat messages to be displayed by a user computer. The request may include any information that may allow the server computer to provide the information being requested by the client computer. For example, a chat message request may include a user identifier and a media identifier to allow a reconfigured media provider to determine a reconfigured media input and a user account associated with the chat message request to determine which chat messages are relevant to the chat message request.

A “response” may include any message or series or messages sent from a server computer to a client computer that provides information requested in the request message. For example, a chat message response may provide chat messages to be displayed by a user computer.

### DETAILED DESCRIPTION

Embodiments of the present invention are directed to methods and systems that facilitate social media viewing of media inputs where the presentation is synchronized by user devices that are located in many different locations but allow users to input non-media related inputs to current and/or subsequent viewers.

The system may allow individual users or groups of users to watch a movie, TV show, live concert, or other media event at the same time from different devices in multiple locations. The system may allow users to post comments and chat amongst segmented viewers and all viewers, ask celebrities questions, purchase products or services from advertisers or those products and services that are relevant to the media input (e.g., event), participate in polls related to the media viewing experience, take quizzes relevant to the viewing experience, share content related to the media input, or otherwise interact with the online event. The system can provide a virtual theater experience where groups of users can meet on a social media website using their electronic devices at numerous different locations and engage in a social activity centered on the media. Additionally, users may use the system individually to have an interactive experience with any media input to create a community with people of similar interests from around the world.

### I. Reconfigured Media Presentation System

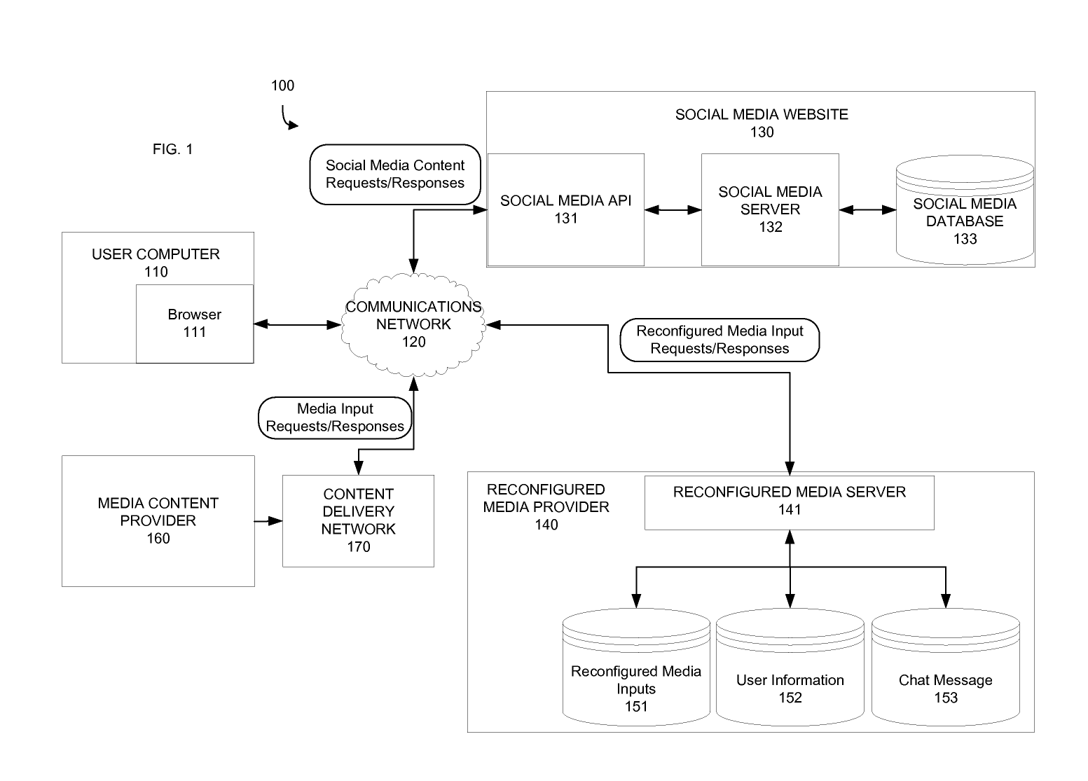

FIG. 1 shows a reconfigured media presentation system 100 for delivering reconfigured media inputs to user computers 110, according to one embodiment of the invention. The reconfigured media presentation system 100 comprises a user computer, a reconfigured media provider 140, a social media website 130, and a content delivery network 170. All of the above entities may be coupled to a communications network 120 that allows each of the entities to send and receive communications to and from other entities.

The reconfigured media presentation system 100 may allow user computers 110 to request and receive reconfigured media inputs that include both media inputs (e.g., movies, videos of plays, concerts, recordings of music, etc.) along with non-media inputs (e.g., chat messages, poll questions, trivia, questions and answers, etc.) related to the media input.

For example, a media content provider 160 may provide a media input to a content delivery network 170 for distribution to user computers 110 through a communications network 120. The content delivery network 170 may reconfigure and store the media input for future delivery. The media input may either be an encoded file of a prior performance, recorded video, recorded event, or a live video feed of a performance or event that may be encoded by the content delivery network 170. The content delivery network 170 may use a media application to reconfigure the media input to a format that can be streamed from the content delivery network 170 to users that request the media input via a social media website 130, reconfigured media provider 140, or directly from the content delivery network 170. In some embodiments, the functionality provided by the content delivery network 170 may also be accomplished by the reconfigured media provider 140 which may host the media inputs directly or may reconfigure the media inputs for distribution and provide them to other content delivery networks (not shown), etc.

The media content provider 160 may also provide the media input to a reconfigured media provider 140 that may generate and/or configure non-media inputs associated with the media input in a reconfigured media input. The reconfigured media input may include non-media inputs that allow users of a social media website 130, the reconfigured media provider 140, or any other third party website to interact with the media input through the user of sharable clips, quotes, songs, and annotated chat. The non-media input options can be added using the social media website's application programming interface (API) 131. The reconfigured media input may include the link to the media input hosted at the content delivery network 170 such that when a reconfigured media input is sent to a user computer 110, the user computer 110 may contact the content delivery network 170 for the media input associated with the non-media inputs. The non-media inputs, APIs for each media input, and the links to the appropriate media inputs at various content delivery networks may be stored in a reconfigured media inputs database 151 at the reconfigured media provider 140. In some embodiments, the reconfigured media provider 140 could also be provided the reconfigured media from another party (not shown) or the media content provider 160 could reconfigure the media prior to providing it to the reconfigured media provider 140.

After generating a reconfigured media input, the reconfigured media server 141 may receive a reconfigured media input request from a user computer 110 to view the media input. Alternatively, the reconfigured media server 141 could receive a reconfigured media request from the social media website 130 to stream the media input to a particular user computer 110. The reconfigured media input may be provided through a communications network 120 to a browser 111 operating on a user computer 110. The Social Media API 131 may allow users to interact with each other using the application programming interface (API) of each social media website 130. Therefore, a different reconfigured media input can be created for different social media websites 130 with different APIs embedded.

The social media API 131 also allows the reconfigured media server 141 access to the user's profile information on the social media database 133 of the social media website 130. The reconfigured media server 141 can also require the user to log in order to determine the user's profile information that is stored by the reconfigured media provider 140 at a user information database 152. Each user account may be identified by a unique user identifier.

The reconfigured media server 141 can create a secure connection or “handshake” with the social media website 130 and deliver the reconfigured media input to the user computer 110. Accordingly, a user may now interact with the reconfigured media input and may provide non-media input relevant to other users viewing the reconfigured media input.

The reconfigured media server 141 may comprise modules for verifying the identity of a requesting user computer 110, sending requests and receiving responses for user profile information from the social media server 132 and social media API 131 stored on the social media database 133 corresponding to the identity of the requesting user (e.g., user identifier associated with the user) at the user computer 110, storing the user information in a user information database 152, generating a reconfigured media input response configured to display on the browser 111 of the user computer 110 in response to the request, including the reconfigured media input and non-media inputs related to social features, and storing interactive chat messages from a plurality of users in a message feed database 153.

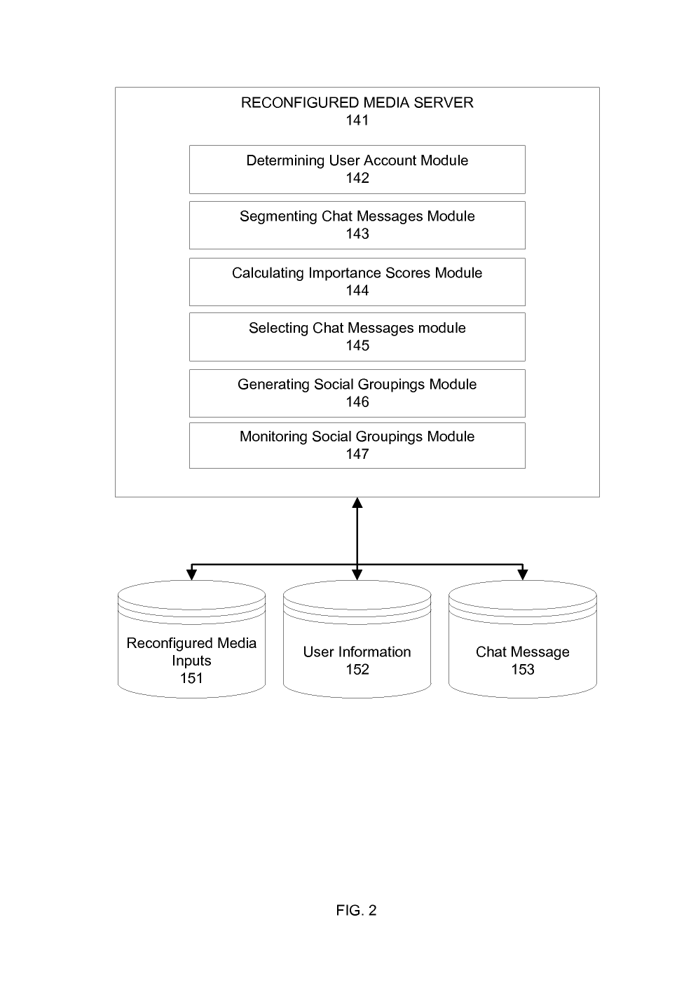

FIG. 2 shows a functional view of an exemplary reconfigured media provider 140, according to embodiments of the present invention. The reconfigured media server 141 may comprise a determining user account module 142, segmenting chat messages module 143, calculating importance scores module 144, selecting chat messages module 145, generating social groupings module 146, and a monitoring social groupings module 147. These modules may communicate with the social media API 131 or social media server 132 in order to receive any requested information from the social media website 130 stored in the social media database 133 about users associated with the social media website 130. Additionally, the modules 142-147 may receive or use any stored information in the reconfigured media inputs database 151, user information database 152, and the message feed database 153. The functionality and operations of these modules is described in more details below.

The determining user account module 142 may include any software configured to receive a request including a user identifier from a user computer 110 and determine a user account, profile, or other user information associated with the user identifier. A user may be provided with a unique account identifier during registration with the reconfigured media provider 140. The user identifier may be included in any reconfigured media requests, chat messages, user interactions, or any other communications initiated by the user computer 110, browser 111 operating on the user computer 110, or any other communication originated by the user. Accordingly, the determining user account module 142 may parse a received message in order to determine the user identifier associated with a message. The determining user account module 142 may then search a user information database 152 for a user account associated with the user identifier. The user account may then include any of the above information related to the user's interactions including user preferences, social media network profile information, and any other relevant information collected by the reconfigured media provider 140.

The segmenting chat messages module 143 may include any software configured to segment, separate, or otherwise reorganize chat messages in the chat message database 153 to identify and evaluate chat messages related to a chat message request associated with a particular user. For example, the segmenting chat messages module 143 may determine a media identifier associated with a chat message request and identify or segment a plurality of chat messages that are associated with the media identifier. The media identifier may be included in a chat message request or may be determined by analyzing the user identifier associated with a request.

Further, the segmenting chat messages module 143 may be configured to determine which chat message channels are relevant to the chat message request and may include any other chat messages from a number of different chat message channels associated with the media identifier. For example, chat messages may be received through a number of different chat message channels including multiple different social media websites 130, fan sites, previously record chat interactions with the reconfigured media input, or any other possible means for a message to be shared with the reconfigured media server 141. Accordingly, chat messages associated with the media identifier that are not received through the social media presentation system may also be segmented into the plurality of chat messages that are analyzed and evaluated for importance or relevance to the chat message request.

Furthermore, the segmenting chat messages module 143 may be configured to segment chat messages from the chat message database 153 based on time, number, relevance, and any other variable that may lead to more useful or relevant chats messages being selected. For example, the segmenting chat messages module 143 may receive a previous chat message time index and may segment the plurality of chat messages to include only the chat messages received since the previous chat message time index.

Additionally, the segmenting chat messages module 143 may limit the plurality of chat messages to a consideration set of chat messages. The consideration set of chat messages may be limited to ten times the specified number of chat messages that may be determined or calculated by the reconfigured media provider 140 or may be received in the chat message request. This process is explained in more detail in the description of the selecting chat messages module 145 below. The segmenting chat messages module 143 may call the selecting chat messages module 145 to determine the specified number of chat messages or may introduce a similar calculation as described below.

A. Calculating Importance Scores

The calculating importance scores module 144 may include any software configured to calculate the importance of chat messages to a user. For example, the calculating importance scores module 144 may calculate an importance score for each and every chat message within a plurality of chat messages to determine the importance of each message to a particular user. An importance score may include any calculation or metric for quantifying the importance of a chat message to a user account. As such, the importance score for each of the chat messages may be different for each and every user account.

The calculating importance scores module 144 may calculate the importance of each message through any number of suitable methods. In one embodiment of the present invention, an importance score is calculated by summing importance points that are assigned based on importance criteria. The importance criteria may include any information associated with the user account or the chat messages being evaluated. For example, the importance criteria may be based on a chat message time (e.g., a chat message consideration number), chat message author, chat message content, and user information associated with a user account. The importance scores may then be determined by summing the importance points provided for each of the importance criteria for each of the plurality of chat messages. An example of an importance score calculation through the use of importance criteria for a portion of a segment of chat messages is provided in Table 1 below.

The importance criteria may provide different importance score values for different importance criteria. For example, the importance criteria may provide more importance points for recently received chat messages than to older chat messages. Further, the importance criteria may provide more importance points for a chat message author that is a persona type of chat message author than a viewer type of chat message author. Additionally, the importance criteria may provide more importance points based on a reputation of the chat message author, when there is a relationship between the chat message author and a user account, when the chat message content matches the preferences of the user account, or any other suitable importance criteria that tends to show a chat message may be more important, interesting, or relevant to a user than a typical chat message.

Importance criteria based on how old the message is or when the chat message was received may be used to ensure that the most up to date comments are displayed to a user instead of outdated messages that may no longer be relevant. Any number of methods may be implemented in order to provide an importance criterion based on the time the chat message was generated or received by the social media presentation system and any number of importance scoring schemes may be implemented to ensure recent messages are found more important than old messages. For example, in one embodiment of the present invention, after the messages are segmented into a consideration set that may be a size based on the specified number of chat messages to be selected, the chat messages are provided with a chat message consideration number. For instance, the chat message consideration number (N) may provide an importance score of N points, where N is the number of the chat message in the set of consideration chat messages. Accordingly, the latest message (e.g., message with consideration number of 100) may get 100 importance points based on it being the 100^{th} message segmented into the consideration set of chat messages and the oldest chat message (e.g., message with consideration number of 1) may receive 1 importance point because it is the first message segmented into the consideration set of chat messages. An example of importance points being provided based on a consideration number (N) is provided in TABLE 1 below.

Importance criteria based on chat message author type may be used to ensure that special sponsors, celebrity authors, or any other persons or entities that the reconfigured media provider 140 has recognized as being important (e.g., “personas”) may be viewed by all users. A persona type of author may include any entity that the system determines is important and whose chat messages may be seen by the majority of users. For example, a persona type of author may be associated with a celebrity, sponsor, system administrator, or any other account that may be useful to have messages seen by the majority of users. Accordingly, an author type of importance criteria may provide importance points to a chat message when the chat message is generated by a persona type of user account. The importance points may be provided in any suitable manner. For example, a variable amount may be provided based on the chat message consideration number (N) of the message, a bonus value independent of the message consideration value, an automatic flag may be provided that ensures the message is always displayed, or any other suitable importance scoring scheme may be implemented.

Importance criteria based on a user's relationship with a chat message author may be used to ensure that a user's friends, family members, or other contacts within social media websites 130, the reconfigured media presentation system 100, or outside the virtual world are seen by the user. When a user indicates that they have a relationship with a user they are more likely to care what that user has to say and their chat messages may already be considered to be more important than the average chat comment from someone unknown to the user. Accordingly, an importance criteria that provides importance points based on whether the chat message author and the user account have a relationship, may be determined and additional importance points may be provided to the associated chat message.

Whether a chat message author and a user account have a relationship may be determined through any suitable method. For example, the user information database 152 may be investigated for the chat message author identifier to determine if the chat message author identifier is registered as a friend, acquaintance, or has had any previous contact with the user account. Further, a social media website's 130 user profile associated with the user identifier may be queried to determine if the user identifier is associated with the chat message author identifier. Additionally, contacts that are shared between the user account and the chat message author's user account may also be determined by receiving a list of both account's friends and comparing for any overlap. Similar methods may be implemented to move to 2 degrees of separation or more. Fewer importance points may be provided depending on whether the user and the chat message author are direct friends, indirect friends, only friends of friends of friends, have merely commented on related posts before, etc. Any other suitable scoring schemes may be implemented as well.

Importance criteria based on user preferences may be used to ensure that messages that are related to content that the user is interested in are more likely to be seen by the user than messages that do not include such content. Accordingly, a user's preferences based on their previous behavior with the reconfigured media provider 140, one or more social media websites 130, and their personal information may provide insight into their preferences. Accordingly, importance points may be provided if the profile of a chat message author and the profile of a user account are similar in their user preferences. For example, if both the user and the chat message author have shown an interest in rock climbing through their previous movie watching, chat groups they join, products they buy, etc., a chat message generated by the author may be provided user preferences points to show it is more important than a typical message. Further, the chat message itself may be searched for keywords or content that matches the user accounts interest. For example, a chat message that states “rock climbing is the best” and the user account shows an interest in rock climbing, may be provided more importance points based on the user's preferences.

Importance criteria based on author reputation may be used to ensure that messages from funny, insightful, interesting, and important chat messages authors are more likely to be seen by users than a typical message. Accordingly, a chat message author's previous chat messages may be tracked and if users indicate that the chat message author's previous chat messages are interesting or important, the chat message author's chat messages may receive more importance points than the average chat message author. A chat message author's reputation may be measured through any suitable manner. For example, the reconfigured media provider 140 may track user interactions with the chat message author's previous chat messages (e.g., how many people commented on the chat message, forwarded the chat message to other users, referenced it in future posts, etc.) or may obtain reputation data from a social media website 130 associated with the chat message author (e.g., how many followers does a user have on Twitter®, how many friends do they have on Facebook®, etc.). Accordingly, importance points may be provided to the chat message based on the chat message author's reputation or previous chat message importance.

Importance criteria based on message content may be used to ensure messages that are positive and engaging are provided more importance points than messages that are self-serving, advertisements, spam, etc. Accordingly, the content of a chat message may be analyzed for keywords that tend to indicate the message is a positive message or that tend to indicate the message is a negative or advertising message. For example, a chat message may be searched for the words “love,” “love,” “amazing,” “!!!,” “great,” etc. to indicate that the message is a positive comment on the subject matter or the user is excited about the content. Accordingly, importance points may be provided to the chat message if such keywords are present in the chat message content.

Additionally, the importance criteria based on message content may further assign or provide points to a chat messages based on the relevance of the chat message content to the media input. For instance, the importance criteria may be met and importance points may be provided for overlapping keywords in the chat message that match predetermined keywords assigned to the media input. For example, a band name, song name, previous concert venue, name of a performer, or any other information may cause the chat message to be awarded importance points.

Alternatively, negative importance points may be provided by the message content if the message content is negative or tends to show that the chat message is an advertisement. For example, a chat message may be searched for the words “hate,” “terrible,” “buy,” “one low monthly payment,” etc., or may search for known spam web addresses, statements, etc. that indicate that the message is negative, may be an advertisement, or otherwise may not be as interesting to users watching a reconfigured media input. If such words are found the system may subtract importance points.

Furthermore, the importance criteria may also wipe out all of the importance points of a chat message that comprises restricted content that is against user agreement with the reconfigured media provider 140 so that the chat message may not be seen by any users. For example, the importance criteria may provide a chat message with 0 importance points, no matter how many other importance criteria the chat message may have if the message has swear words, hate speech, racial slurs, or any other statements that violate a user agreement with the reconfigured media provider 140. Restricted content may include swear words, hate speech, racial slurs, any other information that may be inappropriate or a system administrator may have an interest in removing or that violates a user agreement. Spamming and solicitation messages may also be considered restricted content and may result in an importance score of 0.

An example of an importance score calculation for a portion of a consideration set of chat messages with the above described importance criteria and corresponding importance scores is provided in the table below:

TABLE 1
Example Importance Scoring of Chat Messages

| | | Persona | | | | | | |
|---|---|---|---|---|---|---|---|---|
| | | Author | Author | User | Author | Message | Restricted | |
| Chat | | Type | Relationship | Preferences | Reputation | Content | Content- | |
| ID | N | (3 * N) | (2 *N) | (.5 * N) | (′1.5 * N) | (.75 * N) | (2 * N) | Sum |
| 35645 | 100 | 0 | 0 | 50 | 0 | 0 | 0 | 150 |
| 35644 | 99 | 0 | 0 | 0 | 0 | 0 | −198 | -99 |
| 35643 | 98 | 0 | 0 | 0 | 147 | 0 | 0 | 245 |
| 35642 | 97 | 0 | 0 | 0 | 0 | 72.75 | 0 | 169.75 |
| 35641 | 96 | 0 | 192 | 0 | 0 | 0 | 0 | 288 |
| 35640 | 95 | 285 | 0 | 0 | 0 | 0 | 0 | 380 |
| 35439 | 94 | 0 | 0 | 0 | 0 | −70.5 | 0 | 23.5 |

Table 1 provides a chat identifier (also referred to as a chat message time index), a chat message consideration number, a type of chat message author criteria, a relationship between a chat message and the user account criteria, a user preferences criteria, an author reputation criteria, a message content criteria, and a restricted content criteria. The table also provides an importance score for each chat message that is determined by summing each of the importance points provided by the importance criteria that a chat message triggers.

Table 1 includes may include specified number of chat messages of 10 chat messages and the consideration set of chat messages may include 100 chat messages to ensure the most important chat messages are selected for each user. Accordingly, the segmenting chat messages module 143 may determine a chat message time index (e.g., chat message identifier) from the chat request and may segment the received plurality of chat messages since the chat message time index. The segmenting chat messages module 143 may then select the latest 100 messages (if the consideration ratio is 10:1) in order to obtain a large enough number of chat messages to obtain the most important chat messages for each user.

As shown in the table above, the chat messages consideration number has a large impact on the importance score for a chat message but is not the only factor that determines whether a chat message is selected to be displayed to a user. Further, the impact of the chat message consideration number is more pronounced as the chat messages get older in the segmented consideration set of chat messages. Additionally, in other embodiments, only some or none of the importance points for each criteria may be based on the chat message consideration number (N) because the request interval may be shorter and thus messages at the beginning (e.g., N=1) of the consideration set of chat messages may be nearly as relevant to the current action as the chat messages at the end (e.g., N=10 or N=100). Accordingly, although the chat importance criteria implemented in the example table above calculates the number of importance points based on the chat message consideration number (N), and thus the most recent chat messages that are received by the system obtain an advantage over the earlier chat messages, other importance scoring schemes may be implemented that do not provide such a large advantage to recent messages. Accordingly, the importance scoring may incorporate other importance criteria point scores that are not based on the chat message consideration number (N).

B. Selecting Chat Messages

The selecting chat messages module 145 may include any software configured to select a set of messages to deliver to a user computer 110 in a response to the chat message request. The selecting chat messages module 145 may be capable of ranking, filtering, and selecting the most important chat messages for users once the importance scores have been calculated for the plurality of chat messages. Any method of selecting the most important chat messages may be implemented. For example, the selecting chat messages module 145 may select a specified number of chat messages for a first set of chat messages to be delivered to a user that have importance scores that are highest amongst the plurality of chat messages. In the example shown in TABLE 1, the chat message order would change drastically with the first chat message being the chat message with the chat identifier 35640 and the last chat message being the chat message with the chat identifier 35664. Accordingly, the selecting chat messages module 145 may track the highest importance scores until determining the specified number of messages with the highest importance scores. The selecting chat messages module 145 may then generate and send a response including the first set of chat messages to the user computer 110.

The selecting chat messages module 145 may determine, receive, or calculate the specified number of chat messages to include in a set of chat messages to be sent to a user computer 110. For example, the specified number of chat messages may be associated with the media identifier and the selecting chat messages module 145 may merely determine the specified number of chat messages by analyzing the chat message request or by requesting the specified number from the reconfigured media inputs database 151. Further, the specified number may be provided in the chat message request message sent from the user computer 110.

Alternatively, in some embodiments, the specified number of chat messages may be calculated using a request interval and a chat message display rate associated with the media identifier. The chat message display rate includes how many chat messages the user computer 110 displays over a time period. The chat message display rate may be set according to the type of content and the type of audience for a media input. For example, a media input where the average user account age is 16 may have a much faster chat message display rate than a media input where the average user account age is 45. Accordingly, the chat message display rate may be set according to the preferences based on a media input. It may also be possible to set individual chat message display rates based on the age of a user associated with a user account. Further, chat message display rates may be changed for a reconfigured media input during playback and the chat message display rate may be included in the chat message response message sent to the user computer 110 to inform the user computer 110 of the chat message display rate for this set or the next set of chat messages.

Further, a request interval includes a time period until the user computer 110 sends another chat message request for additional chat messages. The request interval may be dictated by the chat message display rate and the specified number of chat messages in a set of chat messages because the request interval may be set so that the user computer 110 does not run out of chat messages to display to a user during playback. Further, request intervals may be altered in order to optimize traffic on the reconfigured media server 141 computer as the larger the request interval, the fewer messages the server computer may receive. However, the larger the request interval, the higher the likelihood that important and interesting comments are missed by users that otherwise would have seen them. Accordingly, more irrelevant or less important chat messages may be displayed to a user if the interval request is too long. The interval request may also be set by the reconfigured media provider 140 and may be sent to the user computer 110 to inform the user computer 110 when the request interval changes.

Accordingly, the specified number of chat messages, the chat message display rate, and the request interval are inter-related by the following algorithm:

Specified Number=Display Rate*Request Interval (1)

For example, the selecting chat messages module 145 may request a request interval and a chat message display rate associated with the received media identifier from the reconfigured media inputs database 151 and may calculate the specified number of chat messages by multiplying the request interval by the chat message display rate. The request interval may include a time period until the user computer 110 sends a second request. The chat message display rate includes how many chat messages the user computer 110 displays over a time period. Accordingly, by multiplying the two factors, the selecting chat messages module 145 may determine the number of chat messages to select and return in the chat message response.

For example, if the display rate is 1 message every second and the request interval is ten seconds, the specified number of chat messages is 10 chat messages. Accordingly, the reconfigured media provider 140 may select the 10 chat messages with the highest importance scores.

Further, the selecting chat messages module 145 may be capable of altering the specified number while a reconfigured media input is be played for users. For example, the selecting chat messages module 145 may set a new chat message display rate associated with the media identifier and may recalculate the specified number of chat messages using the new chat message display rate. The selecting chat messages module 145 may then include the new chat message display rate in the chat message response sent to the user computer 110. The user computer 110 may update the chat message display rate and may display all of the received chat messages to the user.

The generating social groupings module 146 may include any software configured to generate social groupings based on the users associated with a media identifier. For example, in some embodiments, the generating social groupings module 146 may determine a plurality of user accounts associated with a media identifier and generate social groupings based on profile information for the plurality of user accounts. The generating social groupings module 146 may then segment the plurality of chat messages into chat message streams that correspond to the social groupings or may request the segmenting chat messages module 143 to segment the chat messages into the social groupings.

The generating social groupings module 146 may generate and assign user accounts to social groupings before determining the importance of any particular chat message for any user account. Accordingly, instead of merely segmenting chat messages based on a media identifier, the generating social groupings module 146 may generate a number of different social groupings based on interests of users viewing a reconfigured media input and may segment chat messages related to the reconfigured media before calculating importance scores for the chat messages.

Accordingly, after the generating social groupings module 146 generates the social groupings, assigns a user to a particular social grouping, and segments the plurality of chat messages into segmented chat streams associated with the social groupings, the calculating importance scores module 144 may determine an importance score for each of the plurality of chat messages within the plurality of chat message streams associated with the generated social groupings. The importance scores may be calculated as usual but if one of the importance scores within the chat message streams associated with the social groupings reaches an importance threshold, the chat message may be included in all of the chat streams, no matter what chat stream the chat message author is associated with.

The monitoring social groupings module 147 may include any software configured to monitor the generated social groupings for the reconfigured media input to ensure a social grouping size and a social grouping activity level for each of the social groupings stay within set thresholds. However, if the user sizes or social grouping activity levels reach the thresholds, the monitoring social groupings module 147 may regenerate the social groupings. For example, if the activity level of a social grouping within the plurality of social groupings becomes inactive (e.g., an activity threshold may be set that provides an inactive level of chat messages over a predetermined time period) or if the size of a social grouping within the plurality of social groupings breaches a social grouping size threshold (e.g., more than a predetermined size threshold—e.g., less than 5 users or more than 500 users), then the monitoring social groupings module 147 may regenerate the social groupings, redistribute users through the social groupings, or perform any other suitable method for solving the threshold issues. Users may not know they are being redistributed the redistribution or regeneration Occurs.

The reconfigured media inputs database 151 may comprise any information related to providing reconfigured media inputs including both media inputs and non-media inputs to a user computer 110. For example, the reconfigured media inputs database 151 may store the non-media inputs (e.g., trivia questions and answers content, shareable clips, shareable quotes, etc.) that may be delivered to a user computer 110 to allow the user computer 110 to interact with the media input more fully. The reconfigured media inputs may be stored according to a media identifier that associates all media input and non-media input content to the appropriate underlying reference material.

Additionally, the reconfigured media inputs database 151 may also store user computer 110 settings that may be used when experiencing the reconfigured media input. For example, the reconfigured media inputs database 151 may comprise a chat message display rate, a request interval for the user computer 110, the link or location of the media input stored at the content delivery network 170, an authentication password or other credentials that may be delivered to the content delivery network 170 along with the user request to ensure the user is authorized to view the media input, and any other relevant information related to the user experience and viewing of the reconfigured media input.

The user information database 152 may include any information related to the users registered with the reconfigured media provider 140. For example, the user information database 152 may include user profile information that is shared with the reconfigured media server 141 from one or more social media website 130 that is associated with a user registered with the reconfigured media provider 140. Additionally, the user information database 152 may comprise user account information that may be provided during registration with the reconfigured media provider 140. The user information database 152 may also comprise information regarding users' previous behavior or interactions with the reconfigured media provider 140. For example, previous reconfigured media inputs purchased or any other relevant consumer information that may be captured by the reconfigured media provider 140.

The chat message database 153 may include any messages received by the reconfigured media provider 140 that may be shared with user computers 110. For example, the chat message database 153 may include messages from users viewing a reconfigured media input or messages that may be configured by the reconfigured media provider 140, an advertiser, or other third party that may be displayed during the delivery of a reconfigured media input to a user computer 110.

Although the system and functionality may be described in terms of the reconfigured media server 141 performing the functionality of embodiments of the present invention, one of ordinary skill in the art would recognize that the actions may be performed by multiple entities within the system. Accordingly, embodiments may not be limited to a particular actor performing the actions described and instead the actions could be provided by any of the entities including the social media server 132, another server at the social media website 130, another computer at the reconfigured media provider 140, the browser 111 running on the user computer 110, a third party that implements some of the functionality disclosed, or any other suitable entity in the system.

### II. Methods for Prioritizing Chat

Because many users may attend or access the event (e.g., the reconfigured media input) at the same time and may all want to comment at the same time, there is a need for a method of limiting and prioritizing chats so that users may interact with each other without being overwhelmed by too many chat messages or an unreadable amount of data within a single chat stream. Accordingly, embodiments of the present invention may determine a set of chat messages to evaluate for their importance to a user account and may select a specified number of the most important messages to be displayed to a user.

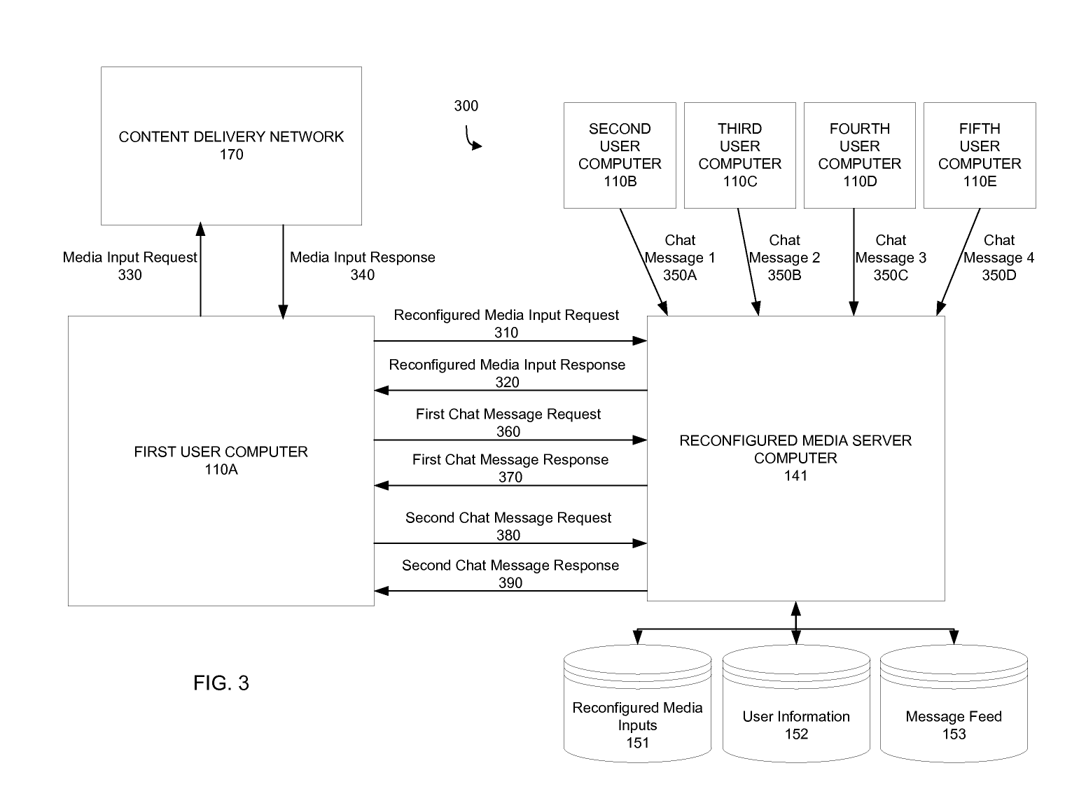

FIG. 3 shows another flow diagram of a method of delivering a reconfigured media input to a first user computer 110A and interacting with multiple user computers 110B-110D within a portion of a reconfigured media presentation system 300, according to one embodiment of the present invention. The portion of the reconfigured media presentation system 300 is shown with arrows showing communications that are sent between entities within the reconfigured media presentation system 300.

At step 310, a first user computer 110A generates and sends a reconfigured media input request to a reconfigured media server computer 141. The reconfigured media input request may include a user identifier associated with the user operating the first user computer 110A. The reconfigured media input request may further comprise a media identifier that is associated with a reconfigured media input offered by the reconfigured media provider 140 for viewing by users. Any additional information may also be included, for example, payment information, social media website 130 credentials for gaining access to the user's profile information stored at the social media website 130, or any other useful information for the reconfigured media provider 140 to provide a reconfigured media input to the user computer.

At step 320, the reconfigured media server 141 may generate and send a reconfigured media input response to the first user computer 110A. The reconfigured media input response may comprise a reconfigured media input associated with the reconfigured media request. The reconfigured media input response may include any non-media inputs associated with the reconfigured media input and may include a media link or other information that informs the first user computer 110A as to how and where to find a media input located at a content delivery network 170.

At step 330, the first user computer 110A may receive the reconfigured media response and if the response is positive (e.g., the reconfigured media finds the media identifier and allows the user to order the reconfigured media input), the first user computer 110A may use the media input link or other information informing the first user computer 110A of where to access the media input to request the media input from the content delivery network 170 associated with the reconfigured media input. Accordingly, the first user computer 110A may generate a media input request and send the media input request to the content delivery network 170. The media input request may comprise any information that may be useful for authenticating the user, identifying the correct media input, and ensuring the user computer as the appropriate rights to access the media input. For example, the media input request may comprise a media identifier, a user identifier, media input credentials provided by the reconfigured media server 141 that authenticates the request as legitimate and that the user has the appropriate rights to access the media input, etc.

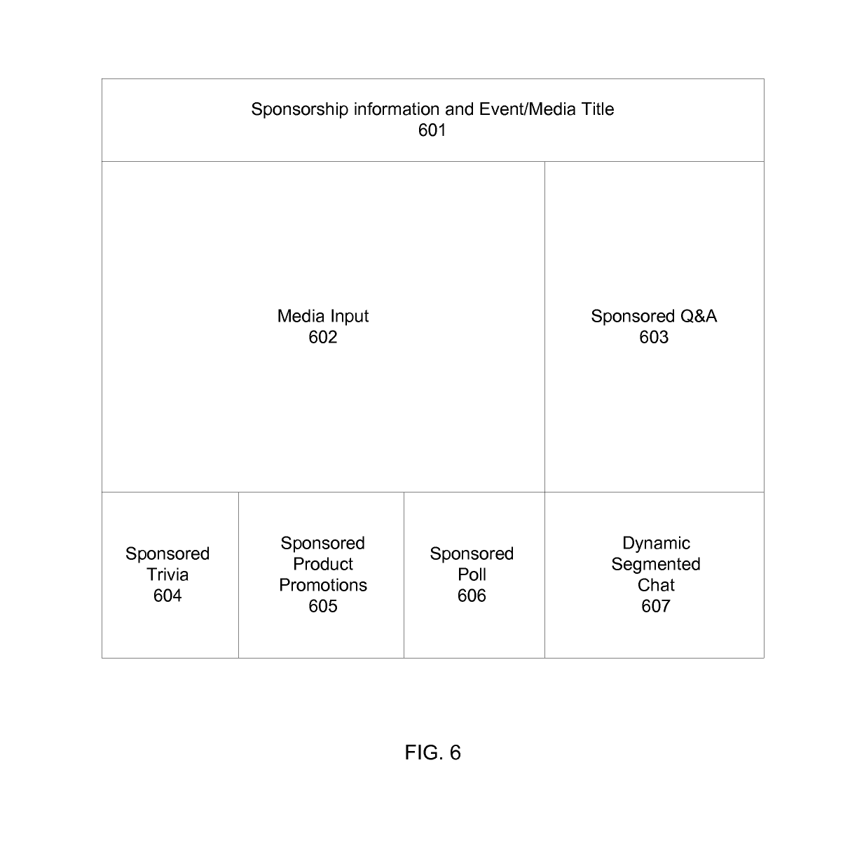

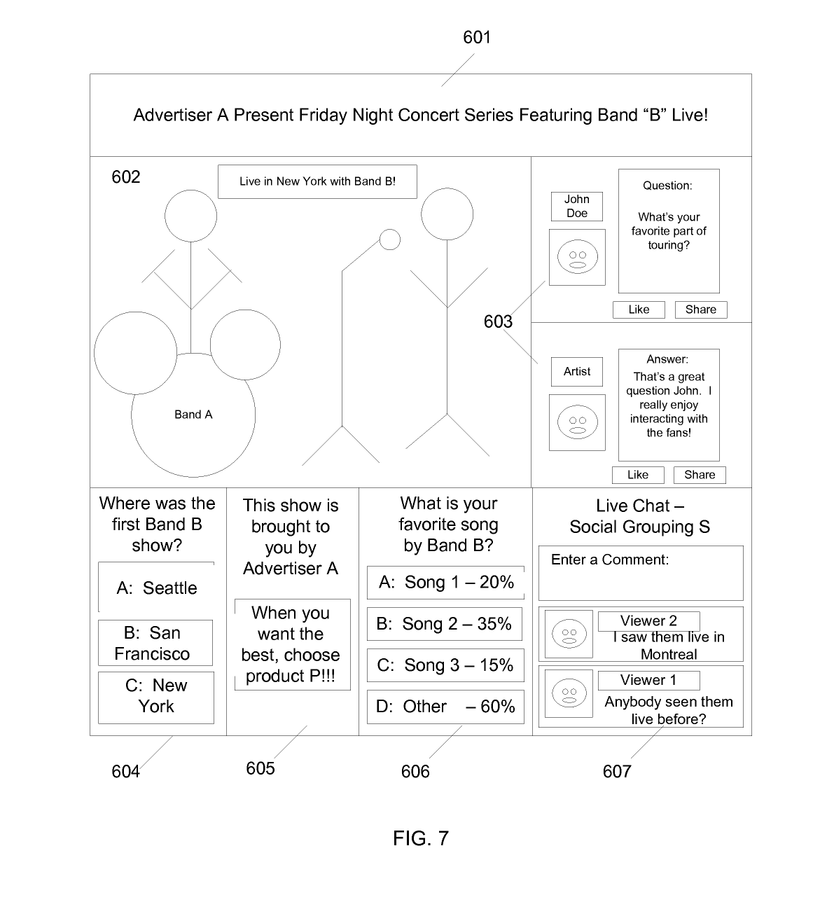

At step 340, the content delivery network 170 receives the media input request, generates a media input response, and sends the media input response to the first user computer 110A. The content delivery network 170 may receive the media input request, may evaluate the media input request for the proper authentication details including the media identifier, media input credentials, and any other information necessary to provide the media input to the user computer. Once the media input is identified and the user computer is authenticated, the content delivery network 170 may generate a media input response that includes all or a portion of the media input. Accordingly, numerous media input requests and media input responses may be sent between the content delivery network 170 and the first user computer 110A in order to ensure the media input is delivered correctly, is buffered, and to ensure downloading delays are not burdensome for the user computer. According, the first user computer 110A may start to view the media input being delivered from the content delivery network 170. Additionally, a media player that is operating on a browser 111 of the first user computer 110A may also show the non-media inputs received from the reconfigured media provider 140 in the reconfigured media input response. For example, at this point a user may see a movie start to play in a media player and trivia questions, sponsor information, etc. may start to display in designated sections around the movie player. Example user interfaces and media player screenshots are shown in FIGS. 6-7. The user interface of the media player will be described in further detail below.

At this point, the first user computer 110A may try to display chat messages. Accordingly, the media player operating on the first user computer 110A may attempt to receive chat messages associated with the media input. While (and even before) the first user computer 110A started establishing a connection with the content delivery network 170, a plurality of other user computers that are experiencing the media input may also be inputting chat messages into their browsers 111 operating on their respective user computers. Accordingly, the second user computer through the fifth user computer may be sending chat messages to the reconfigured media provider 140 through their media players as they are experiencing the media inputs.

At steps 350A-350D, the reconfigured media server 141 receives a plurality of chat messages from a plurality of user computers 110A-110D engaged with the reconfigured media input. The plurality of user computers may receive the reconfigured media input responses and view the event at the same time and may interact with one another by sending chat messages, comments, sharing items, asking questions, or participating through any of the other non-media inputs that are disclosed herein. Accordingly, the reconfigured media server 141 may receive a large number of chat messages to be displayed at the same time in a chat message database 153. These chat messages may be combined into a chat stream data structure that may be stored in the social features database 152 coupled to the reconfigured media server 141.

Furthermore, the second user computer through the fifth user computer may be communicating with the reconfigured media provider 140 through multiple chat message channels including the media player, email messages, social media networks (e.g., twitter, facebook, etc.), or through any other suitable platform for sharing information between users related to a reconfigured media input. Accordingly, the chat messages 1-4 450A-450D may include a plurality of chat messages from a plurality of user computers across multiple message channels. The reconfigured media provider 140 may store the various chat messages in the chat message database 153 and may associate the chat messages with the media identifier included in each chat message received. Furthermore, based on the level of chat message traffic, the various chat message channels may be included in the chat message database 153 or only a primary channel (e.g., the user computers currently viewing the reconfigured media input) may be used in the chat message database 153.

Additionally, the different chat messages 450A-450D may be received at different times during the delivery of the reconfigured media input to the first user computer 110A. For example, chat message 1 and chat message 2 may be received before the first chat message request and chat message 3 and chat message 4 may be received after the first chat message response. Accordingly, chat message 1 and chat message 2 may be analyzed for the first chat message request and chat message 3 and chat message 4 may be analyzed for the second chat message request.

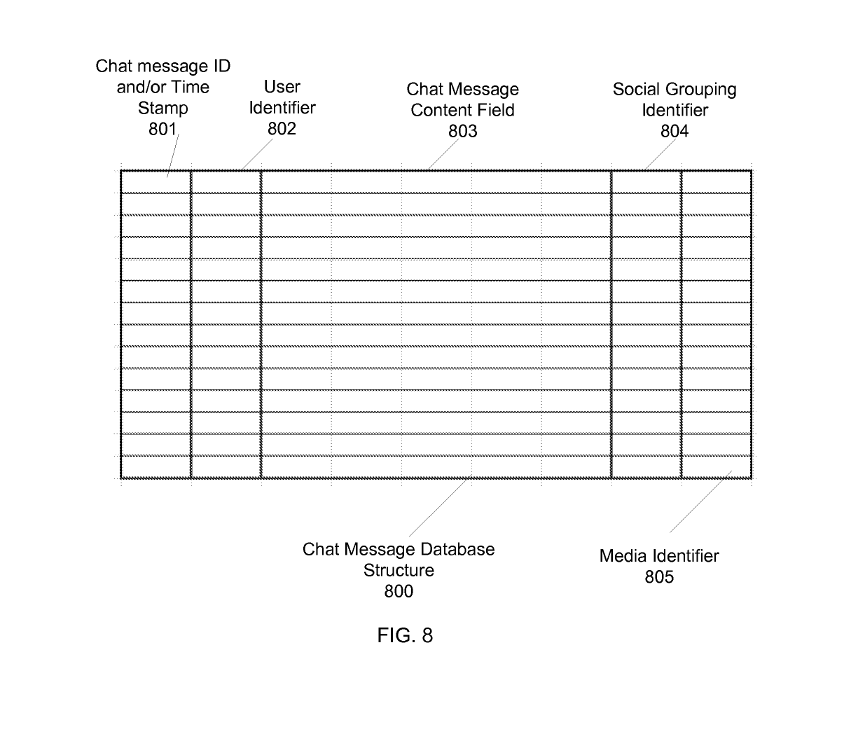

An example of a chat message database 153 structure is shown in FIG. 8. As shown in FIG. 8, the chat message database structure 800 may include a time stamp 801, user identifier 802 associated with an author of the chat message, chat message content field 803 including the content of the chat message, a social grouping identifier 804 (optional), and a media identifier 805 that the chat message is associated with. The chat message database structure may further include any other suitable data fields as one of ordinary skill in the art would recognize. The chat message database structure may be of any suitable size (e.g., 4 gigabits) and may include any number of chat messages received from any number of user computers 110A-110D interacting with the reconfigured media presentation system 300. In many cases, due to the large number of users viewing the reconfigured media input at any given time, if the reconfigured media server 141 were to allow the user computers 110 to display all of these comments at the same time, the comments or chat messages would not be able to be read by any of the users as they would constantly be updated with new chat messages before any chat message could be read. Accordingly, the chat messages within the chat stream may be filtered or segmented to ensure a user may read and interact with chat messages relevant to them. Any other suitable data structure may be implemented for the chat stream as one of ordinary skill in the art would recognize.

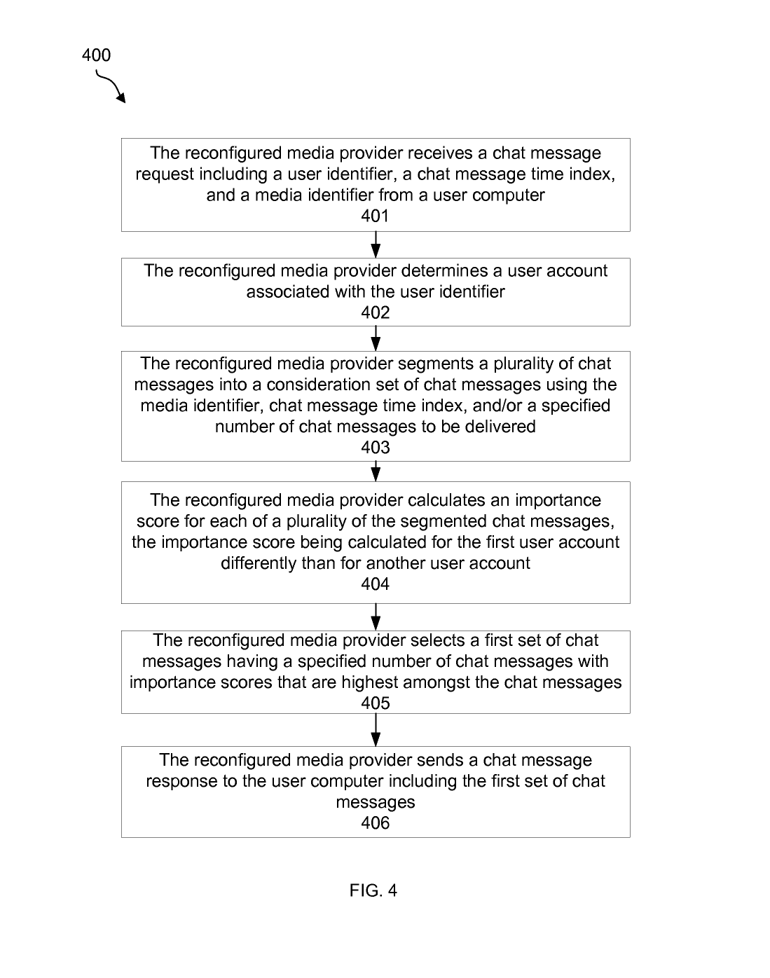

At step 360, the first user computer 110A generates a first chat message request in order to obtain a first set of chat messages from the reconfigured media provider 140. The first chat message request may include a user identifier, a media identifier, a chat message time index, chat message request interval, a chat message display rate, a specified number of chat messages, or any other information that may be useful for determining a first set of chat messages that may be relevant for the user operating the user computer. The reconfigured media server 141 may receive the first chat message request and may determine the most important chat messages for the user account associated with the user computer and the reconfigured media input being delivered to the first user computer 110A from the content delivery network 170. Accordingly, the reconfigured media server computer 141 may perform a method delivering prioritized chat messages to a user computer with the reconfigured media presentation system 300. The method is described in further detail in reference to FIG. 4 below.

FIG. 4 shows a flow diagram of a method of delivering prioritized chat messages to a user computer within a reconfigured media presentation system 300, according to embodiments of the present invention.

At step 401, the reconfigured media provider 140 receives a chat message request including the user identifier associated with the first user computer 110A, a chat message time index, and a media identifier from the first user computer 110A.

At step 402, the reconfigured media provider 140 determines a user account associated with the user identifier. The reconfigured media provider 140 may determine the user account by searching a user information database 152 for a user account associated with the user identifier. The user information database 152 may include a user profile including user preferences, relationships with other users registered with the reconfigured media provider 140, any other information about the user obtained from the social media website 130 user profile, and any other information obtained by the reconfigured media provider 140 while interacting with the user.

At step 403, the reconfigured media provider 140 segments a plurality of chat messages in the chat message database 153 into a consideration set of chat messages using the media identifier, chat message time index, and/or a specified number of chat messages to be delivered.

At step 404, the reconfigured media provider 140 calculates an importance score for each of a plurality of the segmented chat messages. The importance score may be calculated for the first user account differently than for another user account.

At step 405, the reconfigured media provider 140 selects a first set of chat messages having a specified number of chat messages with importance scores that are highest amongst the chat messages.

At step 406, the reconfigured media provider 140 sends a chat message response to the user computer including the first set of chat messages. This step is also shown in FIG. 3 as the first chat message response 370.

Returning to FIG. 3, at step 370, the reconfigured media server computer 141 generates and sends the first chat message response to the first user computer 110A. The first chat response message may include the first set of chat messages, an update chat message time index, and any other relevant information to the social media presentation system.

The chat message time index may be determined as the chat message time of the last message selected or considered for the first set of chat messages. Accordingly, the chat message time index may allow the first user computer 110A to determine the last message that was considered in the previous chat message request. Accordingly, the chat message time index may be provided to the reconfigured media provider 140 in the second chat request message and may allow the reconfigured media provider 140 to determine which messages may be considered since they have not yet been seen or considered for their importance to the first user computer 110A. Accordingly, the chat message time index may allow the reconfigured to quickly and easily determine the last message that was sent or considered by the reconfigured media provider 140. Accordingly, the computing resources necessary to determine the importance points for the plurality of chat messages may be limited because less chat messages may be analyzed by the reconfigured media provider 140. Accordingly, embodiments of the present invention allow for efficient processing when determining the importance calculations for chat messages.

At step 380, the first user computer 110A receives the first chat message response and displays the received chat messages within the chat message response. The user computer may display the chat messages according to a chat message display rate that includes how many chat messages the user computer displays over a time period. For example, the chat message display rate may be 1 chat message per second. Accordingly, the first set of chat messages included in the first chat message response may be displayed to the user in the dynamic chat display area of the media player (element 607 in FIGS. 6-7) at the rate of 1 chat message every second. The first set of chat messages may be displayed according to the chat message display rate until the first set of chat messages are all displayed to the user.

However, before the first user computer 110A displays all of the chat messages in the first set of chat messages, the first user computer 110A may send a second chat message request to the reconfigured media provider 140 to receive new chat messages that have been received by the reconfigured media server computer 141. Accordingly, the first user computer 110A may wait for the duration of a request interval and then may generate and send a second chat message request.

Accordingly, at step 380, the first user computer 110A may wait a predetermined or calculated request interval, during which the media player operating on the first user computer 110A's browser 111 is displaying the first set of chat messages to the user. Once the designated request interval has completed, the first user computer 110A may generate a second chat message request and may send the second chat message request to the reconfigured media server computer 141. The second chat message request may include similar information as the first chat message request described above.

At step 390, the reconfigured media provider 140 may receive the second chat message request and may determine the chat message time index from the chat message request. Accordingly, the reconfigured media provider 140 may request chat messages from the chat message database 153 that have been received since the chat message time index, and may determine the most important or relevant chat messages from the updated plurality of chat messages. Accordingly, the reconfigured may repeat the process described above regarding calculating the importance scores and selecting the specified number of chat messages to obtain a second set of chat messages to be delivered to the first user computer 110A. The reconfigured media provider 140 may then generate a chat message response including the second set of chat messages and may send the chat message response to the first user computer 110A. This process may repeat as long as the first user computer 110A watches the reconfigured media input.

III. Methods for Segmenting Chat into Social Groupings

Alternatively, in some embodiments, chat messages may be further segmented into social groupings based on user characteristics, preferences, relationships, and interests between users before calculating importance scores and an importance threshold may be implemented to ensure that important messages may still be sent to all users. Additionally, there may be a human moderator or the system may implement a chat prioritization algorithm that analyzes the comments, the users making the comments, or any other criteria to determine if an important comment (e.g., a celebrity chat message) may be seen by everyone, and not just those users within a social grouping. In some embodiments, the important comment (e.g., celebrity or persona chat message) may be configured to be displayed to the user in a different section of the user interface from the social grouping chat (as shown in FIGS. 6-7 as “Sponsored Q&A”) or may be highlighted in any other suitable manner. Accordingly, the following method determines social groupings and provides importance scores to chat messages to determine whether a chat may be broadcast to all the users.

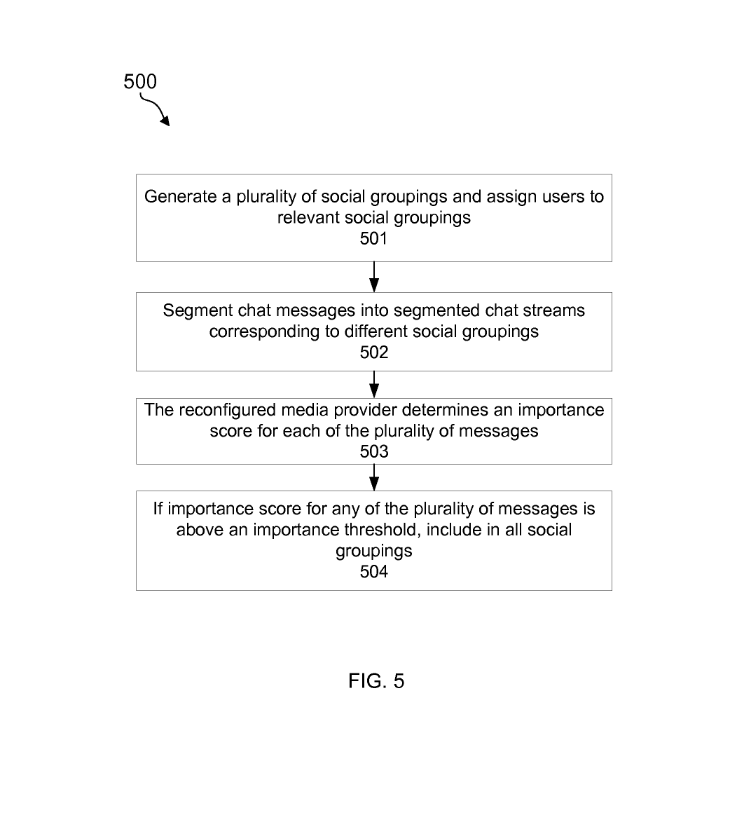

FIG. 5 shows an exemplary method for segmenting chat into social groupings. The method shown in FIG. 5 could be an alternative method of segmenting the plurality of chat messages in a chat message database 153 of the reconfigured media presentation system (step 403) described above in reference to FIG. 4. Accordingly, before the method steps shown in FIG. 5, the reconfigured media server 141 may receive a plurality of chat messages (step 350), a chat message request from a first user computer 110A (steps 360 and 401), and may determine a user account associated with the chat message request (step 402).

At step 501, a social groupings generator module 145 located at the reconfigured media server 141 may generates a plurality of social groupings and assigns users to relevant social groupings based on profile information for the plurality of users, content of a chat message corresponding to a user, and/or the subject matter of the event. The profile information for the plurality of users may be received using any of the methods described herein including requesting information from the social media website 130 or obtaining information from the user information database 152. The social groupings may be generated and determined through any suitable manner. For example, the social groupings may be determined through the use of social mapping.

Social mapping is the process of determining connections between users through the mining of data about those users. For example, a social map may be generated where users who are friends on a social network may be mapped in a direct connection. Furthermore, users who are not direct friends but are friends of friends may be determined to know each other or determined that they may know each other. These individuals may be listed as indirect connections. Although these examples are directed to whether a person is a designated “friend” of another user on the social network, any attribute of a user profile or activity could be used to generate these direct and indirect connections. For example, interests that the user has shown, websites visited, products purchased, or any other minable piece of data about a user could be used to generate social maps for similarities between users. The social mapping may take geographic, age, gender, economic, electronic device used to connect to the system, or any other suitable information that can be captured about the user in order to determine which social grouping the user may be assigned to.

In step 502, a segmenting chat streams module 146 of the reconfigured media server 141 may separate, filter, reorganize the plurality of chat messages from the plurality of users into segmented chat streams corresponding to the different social groupings. The social groupings may be implemented in any suitable fashion. For example, users could be designated as existing in a particular social grouping through use of a flag or other data structure (e.g., the social grouping identifier 805 of FIG. 8) that informs the reconfigured media server 141 that when receiving chat messages from that user, they may be directed to an identified chat stream corresponding to the user's social grouping. The user's comments or chat messages could be sent to separate processors, databases, applications, data bins or buffers, or any other suitable separation of the data based on the determined social grouping that the user is assigned to. Once a user is assigned to a social grouping, the comments sent from that user computer may be directed to a different chat stream, a chat stream that is associated with the determined social grouping. Additionally, a separate data stream may not be implemented and instead the chat messages within the chat message database 153 may be organized in a manner that allows the data to organized and exported to only certain users (e.g., the chat message database structure of FIG. 8 may be used without segmenting). One of ordinary skill in the art would recognize such techniques.

In some embodiments, a social groupings activity monitoring module 148 may operate at the reconfigured media server 141 in order to monitor the size and activity level of each social grouping and dynamically adjust the assignments of the users to ensure that the social groupings maintain a comfortable number of users and activity level. Accordingly, the social groupings activity monitoring module 148 may monitor a size and activity level of the plurality of social groupings and if a social grouping within the plurality of social groupings has an inactive activity level or the size of the social grouping is too small or too large compared to targeted participation levels, the reconfigured media server 141 may regenerate social groupings to meet the targeted participation levels. The social mapping algorithms or other means that the social groupings generator module 141 uses to determine the social groupings may be updated in order to learn new methods of determining connections as a result of this process. For example, if using a particular trait (e.g., favorite movie) leads to inactive groups, the social groupings generator module may change to emphasize other attributes (e.g., favorite sports team) about the users when making social grouping decisions.

At step 503, a calculating importance scores module 144 at the reconfigured media server 141 determines an importance score for each chat message (e.g., as shown as 605 of FIG. 6). The importance score 605 may be determined for each of the plurality of chat messages based on the profile information of each user account, the content of the plurality of chat messages, or based on a special designation assigned to a user account, as described above in the calculating importance scores section. The chat messages may be ranked according to their importance score in order to prioritize chat messages. Accordingly, in some embodiments, the ranking can be used to determine which comments are shown first or are displayed for a longer period of time based on the importance score.

In step 504, if the score of any chat message reaches an importance threshold, the chat message may be sent to all of the social groupings to ensure the chat message may be displayed to all user computers. Accordingly, the calculating importance scores module 144 may implement the importance threshold in any suitable manner that limited the amount of prioritized chats to a suitable and manageable level. For example, the importance threshold could be a particular importance score (e.g., any messages over 300 importance points), could be a flag based on a particular importance criterion (e.g., if persona message, it breaches the importance threshold), or could be based on any other suitable method.

Accordingly, the typical importance scoring, selection, and sending of chat messages to user computers may operate just as in other previously described embodiments. For example, after the importance scores are calculated for each of the importance messages, the specified number of chat messages may be selected according to the same methods described above and may be sent to user computes as described above. Accordingly, the social groupings allow the system to further refine the messages that a user may grade in order to allow for further accuracy or by segmenting chat messages between fans, sides, viewpoints, etc. (e.g., fans for one team may only discuss with that team unless a chat message reaches the predetermined importance score threshold).

### IV. User Experience

FIGS. 6-7 show an example of a user interfaces according to embodiments of the present invention displaying the segmented and prioritized chat. Each of the features shown in FIGS. 6-7 will be addressed in further detail below.

Typically, the reconfigured media presentation system may provide a video player application to users who are logged into a social media website 130. In order for a user to experience a media input using the system, the user would first log into the social media website 130 using registration information provided or received during registration as a member of the social media website 130. The reconfigured media provider could have a site, page, or application within the social media website 130 that could require the user to log into a profile before providing the reconfigured media input, or registration for the reconfigured media provider could be automatic, using the profile registration data already provided during the social media website 130 registration. This data could be stored by the reconfigured media provider in order to authenticate and create account details for the requesting user. A user could then request to play a video or experience other media on the social media website 130 that would open a video player on the user's browser 111 operating on the user computer 110. Next, a security handshake would occur between the social media website server 130, the reconfigured media provider 140, and the content delivery network 170 to ensure that the user requesting the video and the social media website 130 are authenticated. Finally, the video could be delivered to the user via the video player from the content delivery network 170.

FIGS. 6-7 show embodiments of the user interface or video player according to embodiments of the present invention. FIG. 7 shows an example of an event, a live concert 602. A celebrity moderator, an artist in the band, is answering questions during breaks in the concert. If that celebrity enters chat messages, their messages may be provided sufficient importance points to be shown to all the users in area 603. Additionally, as can be seen from the figure, there is a live (e.g., dynamic) chat area 607 that is separate from the sponsored question and answer chat area 603. The persona chat messages (e.g., celebrity comments) may also be shown in the dynamic chat area 607 as well. The dynamic chat area 607 is constantly updated as users within the segmented social group post comments to the event. Further, the dynamic chat area 607 may not be segmented by social groupings and may merely populate with the chat messages with the highest importance points for a user account. Here, viewer 1 and viewer 2 are in the same social grouping S. Accordingly, they can discuss aspects of the media event and interact with one another. Additionally, there are multiple non-media inputs including sponsored trivia 604, sponsored product promotions or advertising 605, as well as a sponsored poll 606. Accordingly, users can engage with the band as well as the sponsor bringing the event to the users.

Further embodiments can be envisioned to one of ordinary skill in the art after reading this disclosure. In other embodiments, combinations or sub-combinations of the above disclosed invention can be advantageously made. The example arrangements of components are shown for purposes of illustration and it may be understood that combinations, additions, re-arrangements, and the like are contemplated in alternative embodiments of the present invention. Thus, while the invention has been described with respect to example of embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

### V. Computer System

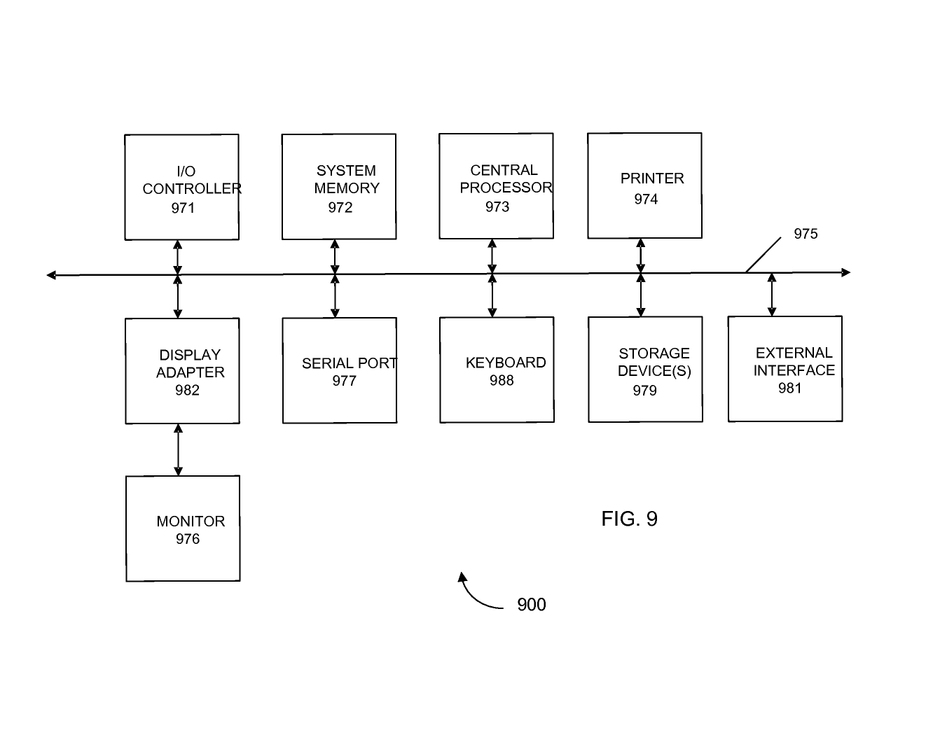

FIG. 9 shows a block diagram of an example computer system 900 usable with system and methods according to embodiments of the present invention.

Any of the computer systems mentioned herein may utilize any suitable number of subsystems. Examples of such subsystems are shown in FIG. 9 in computer apparatus 900. In some embodiments, a computer system includes a single computer apparatus, where the subsystems can be the components of the computer apparatus. In other embodiments, a computer system can include multiple computer apparatuses, each being a subsystem, with internal components.

The subsystems shown in FIG. 9 are interconnected via a system bus 975. Additional subsystems such as a printer 974, keyboard 978, storage device(s) 979, monitor 976, which is coupled to display adapter 982, and others are shown. Peripherals and input/output (I/O) devices, which couple to I/O controller 971, can be connected to the computer system by any number of means known in the art, such as serial port 977. For example, serial port 977 or external interface 981 (e.g., Ethernet, Wi-Fi, etc.) can be used to connect computer system 900 to a wide area network such as the Internet, a mouse input device, or a scanner. The interconnection via system bus 975 allows the central processor 973 to communicate with each subsystem and to control the execution of instructions from system memory 972 or the storage device(s) 979 (e.g., a fixed disk, such as a hard drive or optical disk), as well as the exchange of information between subsystems. The system memory 972 and/or the storage device(s) 979 may embody a computer readable medium. Any of the data mentioned herein can be output from one component to another component and can be output to the user.

A computer system can include a plurality of the same components or subsystems, e.g., connected together by external interface 981 or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g., an application specific integrated circuit or field programmable gate array) and/or using computer software with a generally programmable processor in a modular or integrated manner. As user herein, a processor includes a multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary.

All patents, patent applications, publications, and descriptions mentioned here are incorporated by reference in their entirety for all purposes. None is admitted to be prior art.

What is claimed is:

1. A method for delivering chat messages to a user computer, the method comprising:
receiving a request from the user computer, wherein the request includes a user identifier;
determining a first user account associated with the user identifier;
calculating, by a server, an importance score for each of a plurality of chat messages, the importance score being calculated for the first user account differently than for a second user account;
selecting a first set of chat messages, the first set of chat messages having a specified number of chat messages with importance scores that are highest amongst the chat messages; and
sending a response including the first set of chat messages to the user computer.

2. The method of claim 1, wherein the request includes a media identifier, and wherein the plurality of chat messages are associated with the media identifier.

3. The method of claim 2, wherein the specified number of chat messages is associated with the media identifier.

4. The method of claim 2, wherein the specified number of chat messages is calculated using a request interval and a chat message display rate associated with the media identifier.

5. The method of claim 4, wherein the request interval includes a time period until the user computer sends a second request and wherein the chat message display rate includes how many chat messages the user computer displays over a time period.

6. The method of claim 4, wherein the user computer displays the selected chat messages at the chat message display rate.

7. The method of claim 4, further comprising:
setting a new chat message display rate associated with the media identifier; and
recalculating the specified number of chat messages using the new chat message display rate, wherein the response includes the new chat message display rate.

8. The method of claim 2, wherein the plurality of chat messages includes chat messages from a plurality of chat message channels associated with the media identifier.

9. The method of claim 2, wherein the request includes a previous chat message time index and wherein before calculating the importance score for each of the plurality of chat messages, the method further comprises:
segmenting the plurality of chat messages to include only the chat messages received since the previous chat message time index.

10. The method of claim 9, wherein the plurality of chat messages is limited to a consideration set of chat messages, wherein the consideration set of chat messages is limited to ten times the specified number of chat messages.

11. The method of claim 2, wherein calculating the importance score for each of the plurality of chat messages further comprises:
determining a plurality of user accounts associated with the media identifier;
generating social groupings based on profile information for the plurality of user accounts;
segmenting the plurality of chat messages into chat message streams that correspond to the social groupings;
assigning the user identifier to a first chat message stream; and
determining an importance score for each of the plurality of chat messages within the first chat message stream, the importance score being calculated for the first user account differently than for a second user account.

12. The method of claim 11, wherein if one of the importance scores for the plurality of chat messages within the first chat message stream reaches an importance threshold, including the corresponding chat message in all of the chat message streams.

13. The method of claim 11, further comprising:
monitoring a social grouping size and a social grouping activity level for each of the social groupings; and
regenerating the social groupings if the activity level of a social grouping within the plurality of social groupings is inactive or if the size of a social grouping within the plurality of social groupings breaches a social grouping size threshold.

14. The method of claim 1, wherein calculating the importance score for each of the plurality of chat messages further comprises:
providing importance points to each of the plurality of chat messages using an importance criteria, the importance criteria being based on chat message time, chat message author, chat message content, and user information associated with the first user account; and
summing the importance points provided for each of the importance criteria for each of the plurality of chat messages.

15. The method of claim 14, wherein the importance criteria provides more importance points for recently received chat messages compared to older chat messages.

16. The method of claim 14, wherein the importance criteria provides more importance points for a celebrity type of chat message author compared to a viewer type of chat message author.

17. The method of claim 14, wherein the importance criteria provides importance points based on a reputation of the chat message author.

18. The method of claim 14, wherein the importance criteria provides importance points when there is a relationship between the chat message author and the first user account.

19. The method of claim 14, wherein the importance criteria provides importance points when the chat message content matches the preferences of the first user account.

20. The method of claim 14, wherein the importance criteria subtracts importance points if the chat message content includes restricted content.

21. The method of claim 1, wherein the request is a first request and wherein the response is a first response, the method further comprising:
after sending the first response to the user computer, receiving a new plurality of chat messages from a plurality of user computers;
after a request interval of time, receiving a second request from the user computer, wherein the second request includes the user identifier;
determining the first user account associated with the user identifier;
calculating, by the computer, a second set of importance scores for each of the new plurality of chat messages, the importance scores being calculated for the first user account differently than for a second user account;
selecting a second set of chat messages, the second set of chat messages having the specified number of chat messages with importance scores that are highest amongst the new plurality of chat messages; and
sending a second response including the second set of chat messages to the user computer.

22. A computer product comprising a non-transitory computer readable medium storing a plurality of instructions that when executed control a computer system to deliver chat messages to a user computer, the instructions comprising:
receiving a request from the user computer, wherein the request includes a user identifier;
determining a first user account associated with the user identifier;
calculating an importance score for each of a plurality of chat messages, the importance score being calculated for the first user account differently than for a second user account;
selecting a first set of chat messages, the first set of chat messages having a specified number of chat messages with importance scores that are highest amongst the chat messages; and
sending a response including the first set of chat messages to the user computer.

23. The computer product of claim 22, wherein the request includes a media identifier, and wherein the plurality of chat messages are associated with the media identifier.

24. The computer product of claim 23, wherein calculating the importance score for each of the plurality of chat messages further comprises:
determining a plurality of user accounts associated with the media identifier;
generating social groupings based on profile information for the plurality of user accounts;
segmenting the plurality of chat messages into chat message streams that correspond to the social groupings;
assigning the user identifier to a first chat message stream; and
determining an importance score for each of the plurality of chat messages within the first chat message stream, the importance score being calculated for the first user account differently than for a second user account.

25. The computer product of claim 22, wherein calculating the importance score for each of the plurality of chat messages further comprises:
providing importance points to each of the plurality of chat messages using an importance criteria, the importance criteria being based on chat message time, chat message author, chat message content, and user information associated with the first user account; and
summing the importance points provided for each of the importance criteria for each of the plurality of chat messages.

26. The computer product of claim 22, wherein the request is a first request and wherein the response is a first response, the instructions further comprising:
after sending the first response to the user computer, receiving a new plurality of chat messages from a plurality of user computers;
after a request interval of time, receiving a second request from the user computer, wherein the second request includes the user identifier;
determining the first user account associated with the user identifier;
calculating a second set of importance scores for each of the new plurality of chat messages, the importance scores being calculated for the first user account differently than for a second user account;
selecting a second set of chat messages, the second set of chat messages having the specified number of chat messages with importance scores that are highest amongst the new plurality of chat messages; and
sending a second response including the second set of chat messages to the user computer.
